(19) United States
(12) Patent Application Publication
(10) Pub. No.: US 2001/0046002 A1
(43) Pub. Date: Nov. 29, 2001

(54) Dot inversion mode active matrix liquid crystal display with pre-writing circuit

(76) Inventors: Ming-tien Lin, Lu Chou City (TW); Tean-sen Jen, Ping Chen City (TW); Gow-zin Yiu, Yuan Shan Hsiang (TW); Shao-wu Hsu, Chia Yi City (TW)

Correspondence Address: MARTINE & PENILLA, LLP, 710 LAKEWAY DRIVE, SUITE 170, SUNNYVALE, CA, 94085, US

(21) Appl. No.: 09/823,171

(22) Filed: Mar. 29, 2001

(30) Foreign Application Priority Data
May 29, 2000 (TW) 89110467

(51) Int. Cl. G02F 1/136

(52) U.S. Cl. 349/43

(57) ABSTRACT

In a novel dot inversion mode liquid crystal display, the period of time required to write a pixel electrode is shortened. The liquid crystal display consists of a plurality of pixel cells arranged in a form of matrix. Each of the pixel cells comprises: a pixel electrode for controlling the motion of liquid crystal molecules, a pre-writing transistor, activated by a first scan line, for in advance writing the data signal on a first data line into the pixel electrode, and a main transistor, activated by a second scan line, for writing the data signal in a second data line into the pixel electrode. According to the present invention, the pixel electrode in the liquid crystal display undergoes two separate operations of writing potential voltages with the same polarity per frame of time. Therefore, it is easy to completely write the data signal into the pixel electrode, even when the liquid crystal display becomes higher in the scanning frequency or larger in the resolution degree of the panel.

### BACKGROUND OF THE INVENTION

A. Field of the Invention

The present invention relates to a liquid crystal display with a pre-writing function achieved by a pre-writing transistor to thereby shorten the period of time required to write a pixel electrode. More particularly, the present invention relates to a dot inversion mode active matrix liquid crystal display with a pre-writing function, which is applicable to be operated at an ultra-high frequency and to form a liquid crystal display panel with an ultra-high degree of resolution.

B. Description of the Related Art

In early 1970s, liquid crystal displays have reached to a practical stage and are widely used in application as display panels for electronic watches and calculators. Due to the remarkable advance of semiconductor technology, liquid crystal displays at the present time generally have the advantages of thin size, lightweight, low-voltage driving, and low power consumption. Therefore, the liquid crystal displays are gradually applied as display panels for desktop and laptop computers, hanging televisions, and projection color televisions, instead of the conventional cathode ray tubes.

FIG. 1 is a diagram showing an equivalent circuit of a conventional dot inversion mode active matrix liquid crystal display. For the sake of simplicity, only part of the liquid crystal display, that is, a 3×3 matrix having 9 pixel cells addressed (1,1), (1,2), . . . , (3,2), and (3,3), respectively, is shown in FIG. 1. Each of the pixel cells (i.e., (1,1), (1,2), . . . , (3,2), and (3,3)) consists of a pixel electrode (PE1, PE12, . . . , PE32, or PE33) and an n-channel thin film transistor (N11, N12, . . . , N32, or N33). In the active matrix liquid crystal display, the pixel electrode is used to control the motion of liquid crystal molecules while the n-channel thin film transistor is used as an active switch. The n-channel thin film transistor has a drain, a source, and a gate, which are correspondingly connected to a pixel electrode, a data line, and a scan line, respectively. For example, in the pixel cell addressed (2,2), the drain of the n-channel thin film transistor N22 is connected to the pixel electrode PE22, the source is connected to the data line D2, and the gate is connected to the scan line S2, as shown in FIG. 1. The data lines (i.e., D0, D1, D2, and D3) are parallel with each other, extending in a column direction of the matrix while the scan lines (i.e., S0, S1, S2, and S3) are parallel with each other, extending in a row direction of the matrix.

During the operation of the active matrix liquid crystal display, the n-channel thin film transistor connected to a scan line provided with a high voltage level is activated (ON state), so that the data signal on the data line is written into the pixel electrode through the n-channel transistor. To the contrary, the n-channel thin film transistor connected to a scan line provided with a low voltage level is nonconductive (OFF state) so as to hold the voltage potential of the pixel electrode. Furthermore, in the dot inversion mode active matrix liquid crystal display, the potential of each pixel electrode is opposite in polarity to that of adjacent four pixel electrodes, as shown in FIG. 1 wherein the symbol (+) represents a positive potential while the symbol (−) represents a negative potential, in order to prevent the polarity inversion from flickering during a frame of time.

Along with the continuously increased size, resolution, and operation frequency of the liquid crystal display, the thin film transistor serving as an active switch spends less and less time operating at the ON state. As a result, it is impossible to completely write the data signal on the data line into the pixel electrode during a frame of time, which limits the development of liquid crystal displays. As a countermeasure to the problem described above, a thin film transistor with a wider channel is conventionally used as the active switch to thereby provide a larger writing current. Another countermeasure is to use a scan driver with a more complicated driving method to elongate the total writing time. However, these two prior arts have the following disadvantages, respectively. In the former case, the increased width of the channel results in the increase of total resistance-capacitance (RC) in the liquid crystal display as well as the increase of the gate-source capacitance, and therefore a larger source capacitance and an offset voltage are needed. In the later case, the complication of the driving method provided in the scan driver results in the increased production cost.

### SUMMARY OF THE INVENTION

In view of the above-described drawbacks of the conventional dot inversion mode active matrix liquid crystal display, an object of the present invention is to provide a novel dot inversion mode active matrix liquid crystal display that has a pre-writing function achieved by a pre-writing transistor to shorten the writing time required by the pixel electrode, is applicable to be operated at an ultra-high frequency, and is suitable to form a liquid crystal display with an ultra-high degree of resolution.

In the present invention, the pre-writing function of the liquid crystal display is achieved by a thin film transistor. Compared with the prior art, the production cost of the present invention remains inexpensive since the driving method of the scan driver according to the present invention need no changes.

According to the present invention, an active matrix liquid crystal display with a pre-writing function is provided. The liquid crystal display is operated in a dot inversion mode, comprising a plurality of pixel cells arranged in a form of matrix and a plurality of scan lines and data lines for controlling the plurality of pixel cells. Each of the pixel cells comprises a pixel electrode for controlling the motion of liquid crystal molecules in the pixel cell; a pre-writing transistor having a drain electrically connected to the pixel electrode, a gate electrically connected to a first scan line of the plurality of scan lines, and a source electrically connected to a first data line of the plurality of the data lines, whereby the potential of the first data line is written into the pixel electrode through the pre-writing transistor when the first scan line activates the pre-writing transistor; and a main transistor having a drain electrically connected to the pixel electrode, a gate electrically connected to a second data line adjacent to the first data line, whereby the potential of the second data line is written into the pixel electrode through the main transistor when the second scan line activates the main transistor.

In the dot inversion mode liquid crystal display, the polarity of the potential written in advance by the fist scan line and the first data line, which is called “pre-writing”, is the same as the polarity of the potential written later by the second scan line and the second data line, which is called “main writing”. Therefore, the period of time that is required to have the pixel electrode achieve a desired potential during the main writing is effectively shortened.

### BRIEF DESCRIPTION OF THE DRAWINGS

The above-mentioned and other objects, features, and advantages of the present invention will become apparent with reference to the following detailed descriptions and accompanying drawings, wherein:

FIG. 1 is a diagram showing an equivalent circuit of a conventional dot inversion mode active matrix liquid crystal display;

FIG. 2 is a diagram showing an equivalent circuit of a dot inversion mode active matrix liquid crystal display according to the present invention;

FIGS. 3(a) to 3(e) are voltage versus time graphs showing an operation of the dot inversion mode active matrix liquid crystal display according to the present invention; and

FIGS. 4(a) to 4(e) are voltage versus time graphs showing another operation of the dot inversion mode active matrix liquid crystal display according to the present invention.

### DETAILED DESCRIPTION OF THE PREFERRED EMBODIMENTS

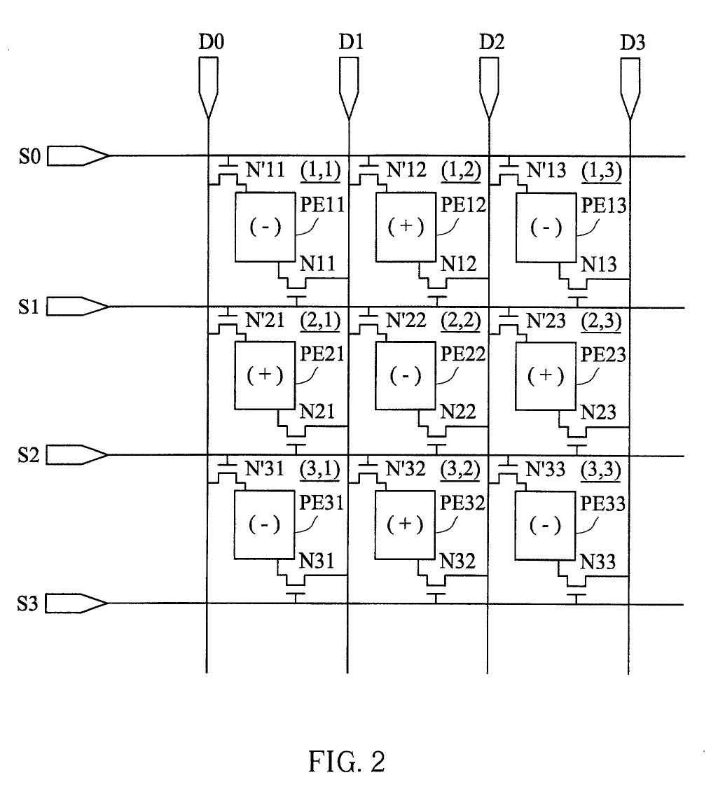

The preferred embodiments according to the present invention will be described in detail with reference to FIGS. 2 to 4.

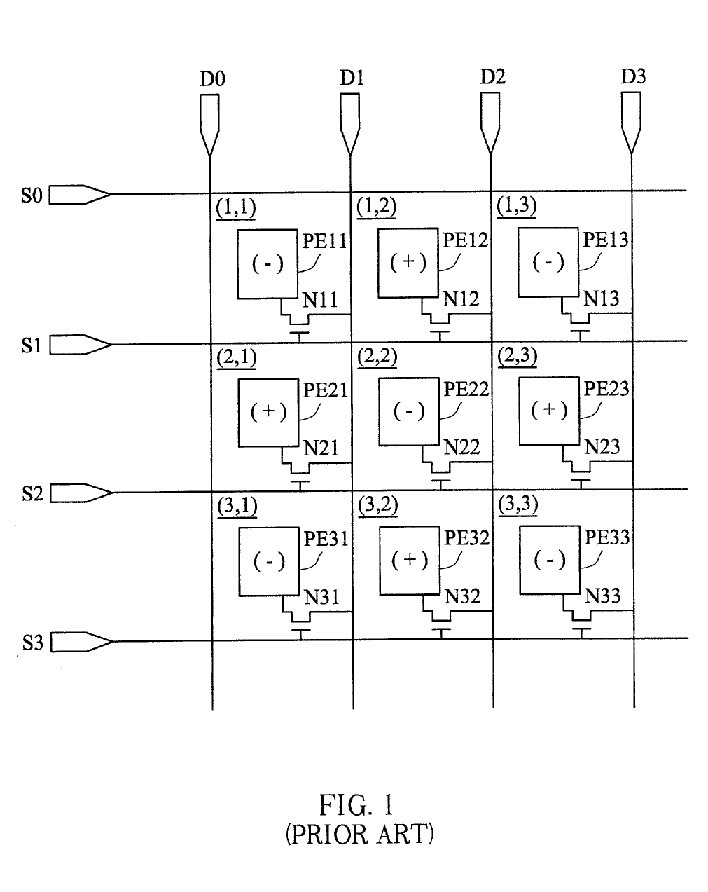

FIG. 2 is a diagram showing an equivalent circuit of a dot inversion mode active matrix liquid crystal display according to the present invention. In the dot inversion mode liquid crystal display, each two adjacent pixel electrodes have opposite polarities in the potential voltage, as shown in FIG. 2 wherein the symbol (+) represents a positive potential while the symbol (−) represents a negative potential, for example. Compared with the conventional dot inversion mode active matrix liquid crystal display shown in FIG. 1, each pixel cell (i.e., (1,1), (1,2), . . . , (3,2), or (3,3)) of the dot inversion mode liquid crystal display shown in FIG. 2 is further provided with a pre-writing n-channel thin film transistor (i.e., N′11, N′12, . . . , N′32, or N′33) for achieving a pre-writing function that is discussed hereinafter. For example, in a pixel cell addressed (2,2), the drain of a pre-writing n-channel thin film transistor N′22 is connected to a pixel electrode PE22, the source thereof is connected to a data line D1, and the gate thereof is connected to a scan line S1. With the arrangement of the pre-writing n-channel thin film transistor N′22, the data signal on the data line D1 is written into the pixel electrode PE22 through the activated pre-writing n-channel thin film transistor N′22 when the potential of the scan line S1 is high. Subsequently, the data signal on a data line D2 is further written into the pixel electrode PE22 through the activated n-channel thin film transistor N22 when the potential of a scan line S2 is high. Consequently, in the dot inversion mode active matrix liquid crystal display according to the present invention, each pixel electrode is twice subjected to a writing operation with the same potential polarity during each frame of time. As a result, the problem involving the incomplete writing is successfully overcome.

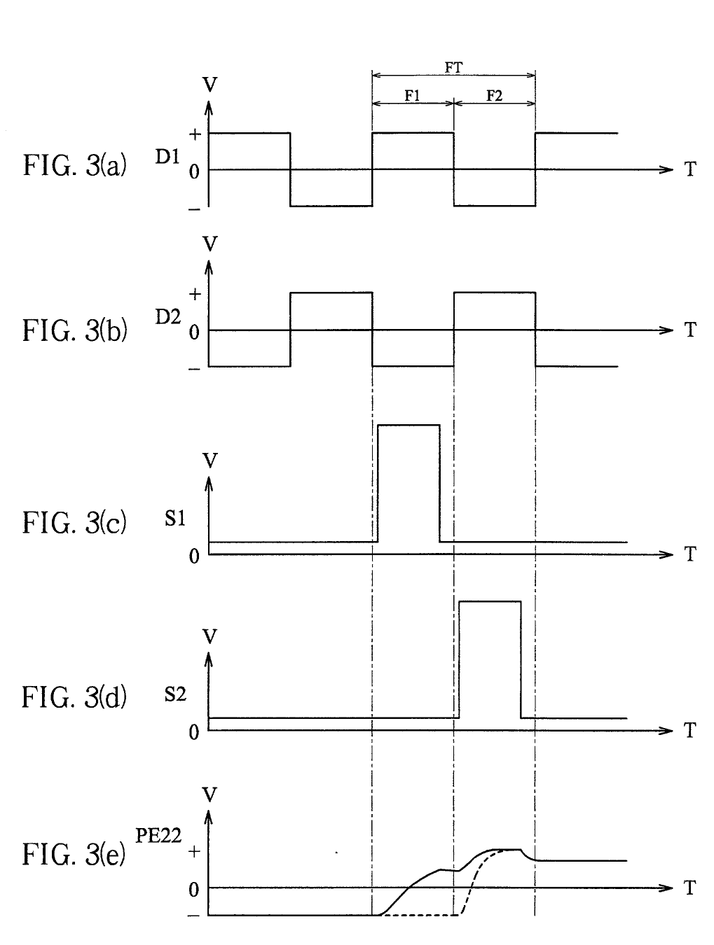

FIGS. 3(a) to 3(e) are voltage versus time graphs showing an operation of the dot inversion mode active matrix liquid crystal display with a pre-writing function shown in FIG. 2. FIGS. 3(a) and 3(b) show the data signals on the data lines D1 and D2, respectively. In the present embodiment, for the sake of simplicity, the data signals transmitted on the data lines D1 and D2 are supposed to be square waves with the same frame FT of time and the same amplitude of voltage. The square waves on the two adjacent data lines D1 and D2 have a phase difference of 180 degrees since the liquid crystal display according to the present invention is operated in the dot inversion mode. Moreover, the frame FT of time in the present embodiment is 41.6 microseconds, divided into two equal fields F1 and F2 of time as shown in FIGS. 3(a) and 3(b).

FIGS. 3(c) and 3(d) show the scan signals on the data lines S1 and S2, respectively. As shown in FIGS. 3(a) and 3(b), the scan direction is from the scan line S1 toward the scan line S2. In the first field F1 of time, the potential of the scan line S1 is high enough to activate the n-channel thin film transistors N11, N12, and N13 shown in FIG. 2, thereby writing the data signals on the data lines D1, D2, and D3 into the pixel electrodes PE11, PE12, and PE13, respectively, which is the same as the operation in the prior art. However, due to the liquid crystal display in this embodiment provided with the pre-writing n-channel thin film transistors N′21, N′22, and N′23 whose gates are all connected to the scan line S1, the pre-writing n-channel thin film transistors N′21, N′22, and N′23 are also activated during the first field Fl of time to thereby write in advance the data signals on the data lines D0, D1, and D2 into the pixel electrodes PE21, PE22, and PE23, respectively. Subsequently, the potential of the scan line S2 is high enough during the second field F2 of time to activate the n-channel thin film transistors N21, N22, and N23, thereby writing the data signals on the data lines D1, D2, and D3 into the pixel electrodes PE21, PE22, and PE23, respectively. Therefore, the pixel electrode in the liquid crystal display according to the present invention undergoes two separate operations of writing potential voltages with the same polarity per frame of time.

FIG. 3(e) shows the potential changes of the pixel electrode PE22 in the dot inversion mode active matrix liquid crystal display. Referring to FIG. 3(e), the solid line represents the potential changes on the pixel electrode PE22 according to the present invention as shown in FIG. 2, while the dashed line represents the potential changes on the pixel electrode PE22 in the prior art as shown in FIG. 1. During the first field F1 of time, the data signal on the data line D1 is written into the pixel electrode PE22 according to the present invention, resulting in the rising of the potential thereon. However, sine there is no pre-writing n-channel thin film transistor N′22 provided in the prior art, the potential of the pixel electrode PE22 in the prior art remains unchanged. During the second field F2 of time, regardless of the present invention and the prior art, the data signal on the data line D2 is written into the pixel electrode PE22. However, since the potential of the pixel electrode PE22 according to the present invention has in advance risen during the first field F1 of time, it takes a shorter time than the prior art during the second field F2 of time to further raise the potential of the pixel electrode PE22 until a desired voltage level.

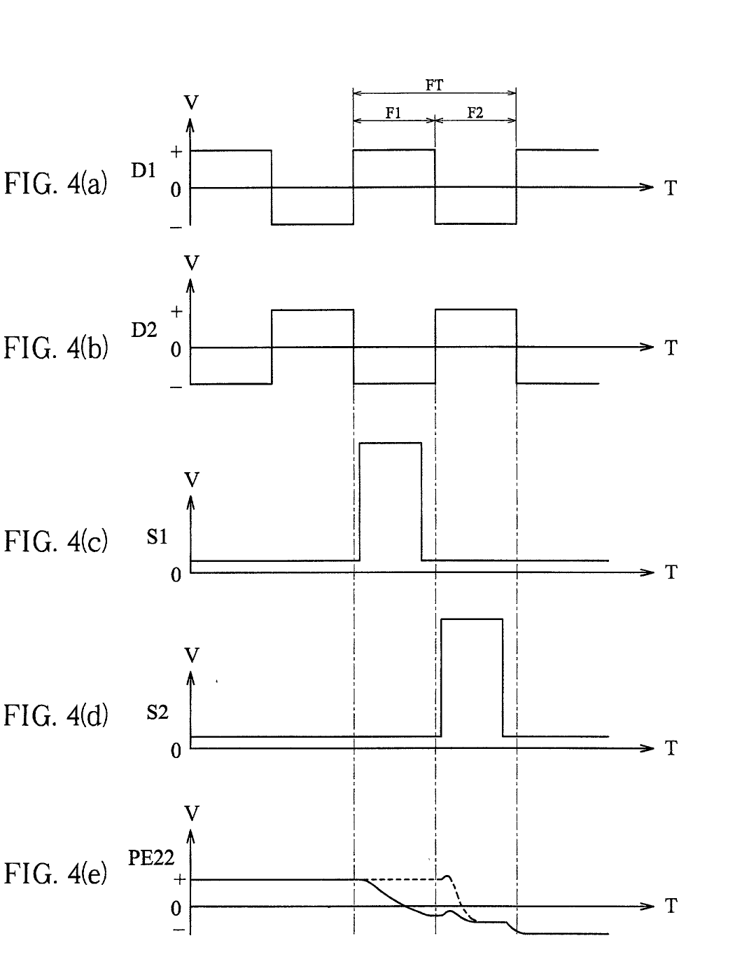

FIGS. 4(a) to 4(e) are voltage versus time graphs showing another operation of the dot inversion mode active matrix liquid crystal display with a pre-writing function shown in FIG. 2. FIGS. 4(a) and 4(b) show the data signals on the data lines D1 and D2, respectively. In the present embodiment, for the sake of simplicity, the data signals transmitted on the data lines D1 and D2 are supposed to be square waves with the same frame FT of time and the same amplitude of voltage. The square waves on the two adjacent data lines D1 and D2 have a phase difference of 180 degrees since the liquid crystal display according to the present invention is operated in the dot inversion mode. Moreover, the frame FT of time in the present embodiment is 41.6 microseconds, divided into two equal fields F1 and F2 of time as shown in FIGS. 4(a) and 4(b).

FIGS. 4(c) and 4(d) show the scan signals on the data lines S1 and S2, respectively. As shown in FIGS. 3(a) and 3(b), the scan direction is from the scan line S1 toward the scan line S2.

FIG. 4(e) shows the potential changes of the pixel electrode PE22 in the dot inversion mode active matrix liquid crystal display. Referring to FIG. 4(e), the solid line represents the potential changes on the pixel electrode PE22 according to the present invention as shown in FIG. 2, while the dashed line represents the potential changes on the pixel electrode PE22 in the prior art as shown in FIG. 1. During the first field F1 of time, the data signal on the data line D1 is written into the pixel electrode PE22 according to the present invention, resulting in the falling of the potential thereon. However, sine there is no pre-writing n-channel thin film transistor N′22 provided in the prior art, the potential of the pixel electrode PE22 in the prior art remains unchanged. During the second field F2 of time, regardless of the present invention and the prior art, the data signals on the data line D2 are written into the pixel electrode PE22. However, since the potential of the pixel electrode PE22 according to the present invention has in advance fallen during the first field F1 of time, it takes a shorter time than the prior art during the second field F2 of time to further reduce the potential of the pixel electrode PE22 until a desired voltage level.

It should be noted that, in the present invention, the transistor achieving the pre-writing function is not limited to the n-channel thin film transistor, but may be a p-channel thin film transistor or transistors of other types, for example. Furthermore, depending on the requirement of the practical application, the channels of the pre-writing thin film transistors N′11, N′12, . . . , N′32, and N′33 according to the present invention may be, in width, equal to, larger than, or smaller than those of the main thin film transistors N11, N12, . . . , N32, and N33.

To sum up, the present invention provides a novel dot inversion mode active matrix liquid crystal display, which achieves a pre-writing function through a pre-writing transistor to thereby shorten the time required to write the pixel electrode. The present invention is easy to completely write the data signals into the pixel electrodes, even when the liquid crystal display becomes higher in the scanning frequency or larger in the resolution degree of the panel.

While the invention has been described by way of example and in terms of the preferred embodiment, it is to be understood that the invention is not limited to the disclosed embodiment. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An active matrix liquid crystal display with a pre-writing function, operated in a dot inversion mode, consisting of a plurality of pixel cells arranged in a form of matrix and a plurality of scan lines and data lines for controlling the plurality of pixel cells, each of the plurality of pixel cells comprising:
a pixel electrode for controlling the motion of liquid crystal molecules in the pixel cell;
a pre-writing transistor having a drain, a gate, and a source, the drain being connected to the pixel electrode, the gate being connected to a first scan line of the plurality of scan lines, and the source being connected to a first data line of the plurality of data lines, thereby writing the potential of the first data line into the pixel electrode through the pre-writing transistor when the pre-writing transistor is activated by the first scan line; and
a main transistor having a drain, a gate, and a source, the drain being connected to the pixel electrode, the gate being connected to a second scan line that is adjacent to the first scan line, and the source being connected to a second data line that is adjacent to the first data line, thereby writing the potential of the second data line into the pixel electrode through the main transistor when the main transistor is activated by the second scan line,
wherein the pre-writing transistor is activated by the first scan line before the main transistor is activated by the second scan line so as to shorten the time required to write the pixel electrode through the main transistor.

2. An active matrix liquid crystal display according to claim 1, wherein the direction along which the plurality of scan lines extend is substantially perpendicular to the direction along which the plurality of data lines extend.

3. An active matrix liquid crystal display according to claim 1, wherein the main transistor is a thin film transistor.

4. An active matrix liquid crystal display according to claim 1, wherein the pre-writing transistor is a thin film transistor.

5. An active matrix liquid crystal display according to claim 1, wherein the channel of the main transistor is in width equal to that of the pre-writing transistor.

6. An active matrix liquid crystal display according to claim 1, wherein the channel of the main transistor is in width larger than that of the pre-writing transistor.

7. An active matrix liquid crystal display according to claim 1, wherein the channel of the main transistor is in width smaller than that of the pre-writing transistor.
